(19) United States
(12) Patent Application Publication
(10) Pub. No.: US 2014/0272031 A1
(43) Pub. Date: Sep. 18, 2014

(54) BLEED RESISTANT COLORED PARTICLES FOR CONFECTIONERY PRODUCTS

(71) Applicant: THE HERSHEY COMPANY, Hershey, PA (US)

(72) Inventors: Kimberly A. STANGL, Manheim, PA (US); Judith K. COOLEY, Hummelstown, PA (US)

(73) Assignee: THE HERSHEY COMPANY, Hershey, PA (US)

(21) Appl. No.: 13/833,787

(22) Filed: Mar. 15, 2013

(51) Int. Cl. A23P 1/08

(52) U.S. Cl. CPC A23P 1/085
USPC 426/250

(57) ABSTRACT

A method of forming edible colored particles is provided that includes providing a plurality of edible non-hygroscopic particles, spraying the plurality of non-hygroscopic particles with an aqueous color system in a coating pan to obtain a plurality of coated particles, tumbling the plurality of coated particles concurrently during at least a portion of the spraying step and drying the plurality of coated particles in the coating pan. The resulting coated particles have a colored exterior and that exhibit resistance to color bleed in environments having a relative humidity up to the hygroscopic limit of the non-hygroscopic particles.

### FIELD

This application is directed to the manufacture of colored particles for confectionery products and more particularly to the manufacture of colored particles that are resistant to color bleed in humid environments.

### BACKGROUND

Edible color particles are widely used as confection toppings and inclusions. Conventional such particles are generally made with materials such as gums, gelatin, stearic acid, and/or silicon dioxide that help adhere or dissolve a pigment in the particle substrate. All of these materials generally absorb water and, as a result, cause the pigment (or even the particle itself) to dissolve when exposed to humid environments, particularly when exposed to high temperatures.

This can result in color bleed that produces a blurred and swollen confetti-like effect that is desirable in some circumstances, particularly with baked goods. However, this effect is much less desirable when the particles are used as inclusions in gum or compressed tablets, such as mints or candy. That problem is further exasperated when the exposure to humid environments happens while products are shipped and/or warehoused in unconditioned spaces prior to sale. This situation can lead to color bleed having already occurred by the time a consumer purchases and opens the package, resulting in an experience that may cause some consumers to believe the contents are not as fresh or desirable as expected.

Furthermore, conventional color particles generally embed the color throughout, meaning that color bleed can occur when the conditions to which the particles are exposed result in the particle exhibiting deterioration, even if the colorant would not itself ordinarily absorb water. Known processes used to produce colored particles are also a time and cost intensive process that requires expensive and specialized equipment, such as fluidized beds and extruders.

These and other drawbacks are associated with current methods of confectionery colored particle production.

### SUMMARY

Exemplary embodiments are directed to producing bleed resistant colored particles for use in confectionery products, such as, but not limited to, hard candies, mints and gums. Surprisingly, despite the use of a water based colorant, the colored particles manufactured in accordance with exemplary embodiments are resistant to color bleeding, even in high temperature and high humidity environments.

In one embodiment, a method for producing edible colored particles includes providing a plurality of edible non-hygroscopic particles, spraying the plurality of non-hygroscopic particles with an aqueous color system in a coating pan to obtain a plurality of coated particles, tumbling the plurality of coated particles concurrently during the spraying step and drying the plurality of coated particles in the coating pan. The plurality of coated particles have a colored exterior that exhibit resistance to color bleed in environments having a relative humidity up to the hygroscopic limit of the non-hygroscopic particles.

In another embodiment, a method for producing edible colored particles includes providing a plurality of edible non-hygroscopic particles selected from the group consisting of isomalt particles, maltitol particles, mannitol particles, erythritol particles, and combinations thereof and having a particle size in the range of about 0.2 millimeters to about 10 millimeters; spraying, in a coating pan, the plurality of non-hygroscopic particles with an aqueous color system containing a water soluble dye, a lake pigment, or a combination thereof to obtain a plurality of coated particles; drying the plurality of coated particles in the coating pan by blowing air over the particles; and tumbling the plurality of coated particles concurrently during at least a portion of each of the spraying and drying steps.

An advantage of exemplary embodiments is that methods described herein produce edible colored particles that yield suitable results without the use of specialized or expensive equipment.

Another advantage is that the methods in accordance with exemplary embodiments provide edible colored particles that are bleed resistant in high temperature and high humidity environments.

Still another advantage includes reduced cost of production. Another advantage is reduced storage costs due to less strict storage requirements, such as a decreased need to store the resulting colored particles in conditioned spaces.

Other features and advantages of the present invention will be apparent from the following more detailed description of exemplary embodiments that illustrate, by way of example, the principles of the invention.

### DETAILED DESCRIPTION OF EXEMPLARY EMBODIMENTS

Exemplary embodiments are directed to methods of producing edible colored particles for confectionery compositions that are resistant to bleeding in high relative humidity environments.

The colored particles are formed by spraying edible non-hygroscopic particles with an aqueous colorant system. During spraying, as well as after, the coated particles are tumbled in a coating pan. The coated particles are then dried in the pan with continued tumbling, typically in combination with a forced air (or other gas) current to yield edible non-hygroscopic particles having a colored exterior. The resulting coated particles are resistant to bleeding even in extremely humid environments, including environments having a relative humidity up to the hygroscopic limit of the edible non-hygroscopic particle.

Any edible non-hygroscopic particles may be employed in conjunction with the methods described herein. It will be appreciated that by “non-hygroscopic particles” is meant particles that do not readily absorb moisture and which are typically understood in the art as having low or very low hygroscopicity (i.e., the hygroscopic limit of the particles is not approached until a high relative humidity is reached). Particularly suitable particles for use in accordance with exemplary embodiments include polyol particles such as isomalt particles, maltitol particles, mannitol particles, erythritol particles, and any combination thereof. Other suitable particles include sugar or acid particles. The edible non-hygroscopic particles typically have a particle size of at least 0.2 millimeters up to about 10 millimeters. In one embodiment, the particles are up to about 1.25 millimeters in size. Although a range of particle sizes may be used with embodiments of the invention, it will be appreciated that the particular particles selected for use in any one pan should be of similar size.

An aqueous colorant system is sprayed onto the exterior surface of the edible non-hygroscopic particles to impart color. Exemplary embodiments may employ either dyes or lakes to impart color. Thus, in some embodiments, the aqueous colorant system is a solution that includes an edible dye and water while in other embodiments, the aqueous colorant system includes a dispersed lake pigment that is suspended in water.

The dye or pigment can be selected from any known synthetic or naturally derived colorants. Examples of synthetic colorants, include, but are not limited to the following dyes and lakes formed therefrom: FD&C Blue No. 1, FD&C Blue No. 2, FD&C Green No. 3, FD&C Red No. 40, FD&C Red No. 3, FD&C Yellow No. 5, FD&C Yellow No. 6, Ponceau 4R, Carmoisine, Patent Blue V and combinations thereof. Examples of naturally derived colorants include, but are not limited to, caramel, annatto, copper chlorophyllin, carmine/cochineal extract, beet juice, saffron, turmeric, beta carotene, black carrot, fruit juices, vegetable juices, paprika, oleoresins, carbon black, spirulina and combinations thereof.

The aqueous colorant system is sprayed in the form of fine droplets onto the exterior surface of the edible non-hygroscopic particles while the particles are tumbled in a coating pan. Spraying may be accomplished in any suitable fashion and may be carried out manually or may be automated and further may use any kind of nozzle to achieve a fine dispersion of liquid particles. Large capacity high volume/low pressure sprayers are preferred and in particular, an electric or another automatic sprayer is preferred, as automatic sprayers are less labor intensive and provide a more consistent application of the color system, resulting in less clumping and less drying time between applications, leading to an overall shorter manufacturing process.

The aqueous colorant system is sprayed such that about 3% to 15% by weight of the non-hygroscopic particles is applied, although it will be appreciated that a significant amount of that weight is water weight that is removed during the drying step and, that as a result, the resulting coating weight in the finished coated particles is something less than that amount. The system is applied in successive applications to avoid introducing too much water to the particle surface in any single coat; typically ten to forty coatings applied over the course of thirty minutes to four hours is appropriate. The edible non-hygroscopic particles are tumbled throughout the spraying process to ensure a more uniform distribution of the colorant, although it will be appreciated that the colorant need not be applied to the particles (or to any individual particle) in an entirely uniform manner.

After application of the colorant is complete, the coated particles are then dried, typically by blowing air into the coating pan. Preferably, the coated particles continue to be tumbled throughout at least a portion of the drying step. The use of a water base colorant system sprayed on non-hygroscopic particles can result in some minor dissolution of the particles on their outer surface during spraying that in turn can lead to clumping. The tumbling action during drying reduces the likelihood of clumping or aggregation of the coated particles to one another. In some embodiments, the coating pan may be tilted backward, which in addition to achieving a more even distribution of coated particles, further reduces clumping. Any clumps that form in the tilted coating pan tend to fall backward into the mix to break apart in the panning action. Clumping can also be reduced using a sheeter, sieve, or sanding drum as a subsequent unit operation.

The drying time between coats is typically about thirty seconds to about five minutes, although longer or shorter times may be employed and may depend upon the temperature and humidity of the air used to dry the particles, as well as the volumetric flow rate of that air if the drying includes forced movement such as blowing. In one embodiment, drying is conducted at room temperature (about 16° C. (60.8° F.) to about 27° C. (80.6° F.)), although temperatures up to about 43.3° C. (110° F.) may be employed. The manufacturing conditions, particularly during the drying step, occur in a relative humidity below about 60%.

The particles are dried to a predetermined moisture content and water activity that is preferably selected to match or at least be compatible with that of the product in which the colored particles will be employed. For example, if the particles are to be used as inclusions for a compressed tablet, the particles are dried to a moisture content and water activity corresponding to the base ingredient in the pressed tablet. By way of further example, for a compressed tablet made of isomalt having a water activity of 0.34, the coated particles should have a water activity in the range of 0.3 to 0.4. As a result, moisture migration from the particles to the pressed tablet is minimized, thereby further decreasing color bleed.

Although some limited dissolution at the particle surface may occur, the spraying is carried out so that no bulk dissolution of the particles occur. The colorant system generally does not penetrate the surface of the non-hygroscopic particles but instead coats the surface region.

In order to achieve a desired level of color application and to build up the total desired coating weight, the spraying, tumbling, and drying can be repeated as necessary. The desired coating weight is typically an application of the coloring system of about 3% weight to about 15% weight of the weight of the provided non-hygroscopic particles.

Optionally, the resulting color particles may be sieved to remove any clumps that remain after tumbling. Those remaining clumps may be subjected to further tumbling or otherwise broken apart to achieve a more uniform particle size.

The resulting colored particles can then be used as inclusions or toppings in confectionery products. It has been observed that colored particles made in accordance with the methods described herein surprisingly exhibit bleed resistance and do not degrade even when exposed to a relative humidity up to the hygroscopic limit of the particular edible non-hygroscopic particles employed, which in some cases is 85% or even 93% relative humidity or higher, reflecting the colored particles' ability to be used in high temperature and high humidity environments.

### EXAMPLES

The invention is further described in the context of the following examples, which are presented by way of illustration, not of limitation.

### Example 1

An aqueous colorant system was produced by mixing two dyes and water in a container with a spatula until a transparent blue aqueous colorant system was formed. The ingredients and weights of each are illustrated in Table 1, below. The aqueous colorant system was then transferred to a two gallon manual pump sprayer.

TABLE 1

| Ingredient | % weight | Weight(lbs) |
|---|---|---|
| Warm water | 99.54 | 14.931 |
| FD&C Blue #1 dye | .23 | 0.0345 |
| FD&C Blue #2 dye | .23 | 0.0345 |
| Total | 100.00 | 15 |

A coating pan, 42″ Stokes stainless steel ribbed pan, was loaded with about 275.5 lbs of isomalt particles (0.2 mm to 0.7 mm particle size distribution of Isomalt ST-F obtained from BENEO, Inc. of Morris Plains, N.J.). The coating pan was rotated at about 28 rpm while the aqueous colorant system was sprayed on the plurality of non-hygroscopic particles using the manual pump sprayer, in which the nozzle was adjusted to spray on its finest setting. The coated particles were allowed to air dry between spray applications as illustrated by Table 2, below. The total time for application of the aqueous colorant system to the plurality of particles was about 1.6 hours. The relative humidity of the room during the experiment was about 44.3% and the room temperature was about 19.6° C. The drying air had a relative humidity of about 37% and a temperature of about 19.6° C. and was blown through the pan for the period of time identified as “Air time” for each application. The water activity of the resulting particles of Example 1 (as well as for Examples 2 and 3) was determined to be in the range of 0.34 to 0.38.

TABLE 2

| | Wt color system | Total wt color system | |
|---|---|---|---|
| | applied | applied | Air time |
| Application | (lbs) | (lbs) | (min) |
| 1 | 0.57 | 0.57 | 2 |
| 2 | 0.27 | 0.84 | 2 |
| 3 | 0.28 | 1.12 | 1 |
| 4 | 0.26 | 1.38 | 2 |
| 5 | 0.56 | 1.94 | 2 |
| 6 | 0.86 | 2.8 | 1 |
| 7 | 0.3 | 3.1 | 1 |
| 8 | 0.18 | 3.28 | 1 |
| 9 | 0.2 | 3.48 | 3 |
| 10 | 0.24 | 3.72 | 3 |
| 11 | 0.36 | 4.08 | 1 |
| 12 | 0.44 | 4.52 | 2 |
| 13 | 0.68 | 5.2 | 3 |
| 14 | 0.42 | 5.62 | 3 |
| 15 | 0.86 | 6.48 | 2 |
| 16 | 0.54 | 7.02 | 5 |
| 17 | 1.02 | 8.04 | 5 |
| 18 | 0.86 | 8.9 | 1 |
| 19 | 0.48 | 9.38 | 2 |
| 20 | 0.82 | 10.2 | 5 |
| 21 | 0 | 0 | 8 |

### Example 2

An aqueous colorant system was produced by mixing two lake pigments and water in a container with a spatula until a substantially transparent blue dispersion was formed. The ingredients and weights of each are illustrated in Table 3, below. The aqueous colorant system was transferred to a two gallon manual pump sprayer.

TABLE 3

| Ingredient | Weight % | Weight (lbs) |
|---|---|---|
| Warm water | 99.46 | 14.92 |
| 5517 FD&C Blue #1 lake (30% dye) | 0.27 | 0.04 |
| 5627 FD&C Blue #2 lake (35% dye) | 0.27 | 0.04 |
| Total | 100.00 | 15 |

A coating pan, 42″ Stokes stainless steel ribbed pan, was loaded with about 330.7 lbs of isomalt particles (0.2 mm to 0.7 mm particle size distribution of Isomalt ST-F obtained from BENEO, Inc. of Morris Plains, N.J.). The coating pan was rotated at about 28 rpm while the aqueous colorant system was sprayed on the plurality of non-hygroscopic particles using the manual pump sprayer. As in Example 1, the nozzle was adjusted to the finest spray setting. The aqueous colorant system was periodically agitated while spraying to keep the pigment in suspension. The coated particles were allowed to air dry between spray applications as illustrated by Table 4, below. The total time for application of the aqueous colorant system to the plurality of particles was about 1.6 hours. The relative humidity of the room during the experiment was about 45.0% and the room temperature was about 19.7° C. The drying air had a relative humidity of about 37% and a temperature of about 19.6° C.

TABLE 4

| | Wt color system | Total wt color system | |
|---|---|---|---|
| | applied | applied | air time |
| Application | (lbs) | (lbs) | (min) |
| 1 | 0 | 0 | 1 |
| 2 | 0.58 | 0.58 | 4 |
| 3 | 0.5 | 1.08 | 4 |
| 4 | 0.46 | 1.54 | 4 |
| 5 | 0.36 | 1.9 | 4 |
| 6 | 0.36 | 2.26 | 4 |
| 7 | 0.58 | 2.84 | 2 |
| 8 | 0.5 | 3.34 | 4 |
| 9 | 1.3 | 4.64 | 2 |
| 10 | 0.46 | 5.1 | 4 |
| 11 | 1.04 | 6.14 | 3 |
| 12 | 0.9 | 7.04 | 3 |
| 13 | 1.2 | 8.24 | 3 |
| 14 | 0.86 | 9.1 | 4 |
| 15 | 0.98 | 10.08 | 2 |
| 16 | 0.96 | 11.04 | 4 |
| 17 | 0.86 | 11.9 | 4 |
| 18 | 1.25 | 13.15 | 4 |
| 19 | 0 | 0 | 6 |

### Example 3

An aqueous colorant system was produced by mixing two lake pigments and water in a container with a spatula until a substantially transparent blue dispersion was formed. The ingredients and weights of each are illustrated in Table 5, below. The aqueous colorant system was transferred to a high volume/low pressure paint sprayer (Wagner Spray Control).

TABLE 5

| Ingredients | Weight % | Weight |
|---|---|---|
| Warm water | 97.31 | 14.6 |
| FD&C Blue #1 lake (10-15% dye) | 2.00 | 0.3 |
| FD&C Blue #2 lake (35% dye) | 0.69 | 0.1 |
| Total | 100.00 | 15 |

A coating pan, 42″ Stokes stainless steel ribbed pan, was loaded with about 330.7 lbs of isomalt particles (0.2 mm to 0.7 mm particle size distribution of Isomalt ST-F obtained from BENEO, Inc. of Morris Plains, N.J.). The coating pan was rotated at about 28 rpm while the aqueous colorant system was sprayed on the plurality of non-hygroscopic particles using the electric sprayer, which was set at a flow rate of 0.8 gal/min. The aqueous colorant system was periodically agitated while spraying to keep the pigment in suspension. The coated particles were allowed to air dry between spray applications as illustrated by Table 6, below and the total weight of colored applied was measured at various intervals. The total time for application of the aqueous colorant system was about 1.3 hours during which a total of about 12.5 pounds of the colorant system was added. The relative humidity of the room during the experiment was about 37.5% and the room temperature was about 22.0° C. The drying air had a relative humidity of about 36.6% and a temperature of about 19.7° C.

TABLE 6

| | Spray time (sec) at | Air time |
|---|---|---|
| Application | 0.8 gal/min | (min) |
| 1 | 0 | 1 |
| 2 | 30 | 3 |
| 3 | 20 | 3 |
| 4 | 20 | 3 |
| 5 | 20 | 3 |
| 6 | 20 | 3 |
| 7 | 30 | 3 |
| 8 | 60 | 3 |
| 9 | 60 | 3 |
| 10 | 30 | 3 |
| 11 | 30 | 3 |
| 12 | 30 | 3 |
| 13 | 40 | 3 |
| 14 | 40 | 3 |
| 15 | 45 | 3 |
| 16 | 60 | 5 |
| 17 | 60 | 5 |
| 18 | 60 | 4 |
| 19 | 60 | 5 |
| 20 | 60 | 5 |
| 21 | 0 | 8 |

### Example 4

The particles of Examples 1 and 3 were compared with commercially available coated particles including EVOGRAN®, a granulated/microencapsulated flavoring avaliable from Symrise Inc., Teterboro, N.J.; EVOGLASS®, an extruded flavoring in a vitreous matrix, also avaliable from Symrise Inc., Teterboro, N.J.; DURAROME®, an encapsulated flavoring agent avaliable from Firmenich Inc., Plainsboro N.J.; and FLEXAROME®, an encapsulated flavoring agent, also available from Firmenich Inc., Plainsboro N.J., all of which are believed to be made according to known conventional processes.

An equal amount (by weight) of particles of each of Examples 1 and 3 and the comparative products were placed on a glass dish and placed in an environmentally controlled chamber for 24 hours in which the temperature was maintained at about 38.9° C. (102° F.) and at 80% relative humidity. Upon removal, each of the commercially available coated particles were observed to have formed liquid puddles, indicative of bleeding had they been incorporated into a confectionery product. Conversely, each of the particles of Examples 1 and 3 reflected bleed resistance as the particles substantially retained their individual character and no puddling of any kind was observed.

### Example 5

In another example, the particles of Examples 1 and 3 were both used as inclusions to form a mint flavored xylitol-based pressed tablet. A comparative example using DURAROME® colored particles was also created. All three pressed tablets were placed on a glass dish and candy tablet stability was tested. At the start of the trial, the colored particles in all three tablets looked the same and the tablets were essentially indistinguishable from one another. The dish and tablets were then placed in an environmentally controlled chamber for one week in which the temperature was maintained at about 38.9° C. (102° F.) with 80% relative humidity. At the conclusion of the week, the tablets were removed from the chamber. The comparative tablets manufactured with the DURAROME® colored particles showed signs of significant color bleeding into the tablet. The pressed tablets made using the colored particles of Examples 1 and 3 each exhibited little to no discernible color bleed.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of forming edible colored particles comprising:
providing a plurality of edible non-hygroscopic particles;
spraying the plurality of non-hygroscopic particles with an aqueous color system in a coating pan to obtain a plurality of coated particles;
tumbling the plurality of coated particles concurrently during the spraying step; and
drying the plurality of coated particles in the coating pan,
wherein the plurality of coated particles have a colored exterior that exhibit resistance to color bleed in environments having a relative humidity up to the hygroscopic limit of the non-hydroscopic particle.

2. The method of claim 1, wherein the step of drying comprises blowing air into the coating pan while tumbling the coated particles.

3. The method of claim 1, wherein the plurality of edible non-hygroscopic particles are selected from the group consisting of isomalt particles, maltitol particles, mannitol particles, erythritol particles, and combinations thereof.

4. The method of claim 1, wherein the step of providing includes providing a plurality of edible non-hygroscopic particles have a particle size of about 0.2 millimeters up to about 10 millimeters.

5. The method of claim 1, wherein the plurality of coated particles have a particle size of up to about 1.25 millimeters.

6. The method of claim 1, wherein the step of spraying comprises spraying an aqueous solution comprising water and a water soluble coloring.

7. The method of claim 6, wherein the water soluble coloring is a dye selected from the group consisting of FD&C Blue No. 1, FD&C Blue No. 2, FD&C Green No. 3, FD&C Red No. 40, FD&C Red No. 3, FD&C Yellow No. 5, FD&C Yellow No. 6, Ponceau 4R, Carmoisine, Patent Blue V and combinations thereof.

8. The method of claim 6, wherein the water soluble coloring is a naturally derived colorant selected from the group consisting of caramel, annatto, copper chlorophyllin, carmine/cochineal extract, beet juice, saffron, turmeric, beta carotene, black carrot, fruit juices, vegetable juices, paprika, oleoresins, carbon black, spirulina and combinations thereof.

9. The method of claim 1, wherein the step of spraying comprises spraying a lake pigment suspended in water.

10. The method of claim 1, wherein the step of spraying comprises spraying the aqueous colorant system in an amount that is about 3% weight to about 15% weight of the total weight of the plurality of edible non-hygroscopic particles.

11. The method of claim 1, wherein the step of drying is carried out for a period of at least 30 seconds.

12. The method of claim 1, wherein the step of drying is conducted at a temperature from about 10° C. to about 45° C.

13. The method of claim 1, wherein the step of drying uses air having a relative humidity in range of 0 to about 60%.

14. The method of claim 1, wherein the step of drying comprises drying the coated particles to achieve a pre-determined moisture content and water activity.

15. A method of forming edible colored particles comprising:
providing a plurality of edible non-hygroscopic particles selected from the group consisting of isomalt particles, maltitol particles, mannitol particles, erythritol particles, and combinations thereof and having a particle size in the range of about 0.2 millimeters to about 10 millimeters;
spraying, in a coating pan, the plurality of non-hygroscopic particles with an aqueous color system containing a water soluble dye, a lake pigment, or a combination thereof to obtain a plurality of coated particles;
drying the plurality of coated particles in the coating pan by blowing air over the particles; and
tumbling the plurality of coated particles concurrently during at least a portion of each of the spraying and drying steps,
wherein the plurality of coated particles have a colored exterior that exhibit resistance to color bleed in environments having a relative humidity up to the hygroscopic limit of the non-hygroscopic particles.
